(19) United States
(12) Patent Application Publication
(10) Pub. No.: US 2006/0109501 A1
(43) Pub. Date: May 25, 2006

(54) Printer-based modem

(76) Inventor: Charles E. Evans, Corvallis, OR (US)

Correspondence Address: AVAGO TECHNOLOGIES, LTD., P.O. BOX 1920, DENVER, CO, 80201-1920, US

(21) Appl. No.: 10/997,572

(22) Filed: Nov. 24, 2004

(51) Int. Cl. G06F 3/12

(52) U.S. Cl. 358/1.15

(57) ABSTRACT

A printer includes print circuitry, an input/output interface, a modem interface and a controller. The input/output interface provides connection to a computer. The modem interface allows the printer to connect to the internet. The controller handles computing overhead when the computer connects to the internet through the modem interface.

### BACKGROUND

In order to facilitate networked communication, for example, most personal computers come equipped with an internal modem or have the ability to connect with an external modem. The type of modem used depends, for example, upon the transmission media for the network. For example, the modem may be for telephone line, cable or digital subscriber line (DSL) connection.

In order to reduce the amount of circuitry necessary to implement a modem, software modems can be used. Software modems replace some of the circuitry on a modem with software programs and drivers that perform a similar function. This can result in a cost saving on the price of a modem, since software modems remove some of the components from the actual modem itself. One big drawback with this design is that the main system processor of the computer system is forced to perform tasks that were formerly done with dedicated hardware on the modem. This can cause a slowdown of operation of the computer system since the software modem requires central processing unit (CPU) cycles to perform its work.

Another drawback of software modems is that software compatibility is not necessary uniform across operating systems. For example, a WinModem based software modem can be used on a Windows based computer system, but is not currently compatible with the Macintosh operating system or the Linux operating system.

### SUMMARY OF THE INVENTION

In accordance with an embodiment of the present invention, a printer includes print circuitry, an input/output interface, a modem interface and a controller. The input/output interface provides connection to a computer. The modem interface allows the printer to connect to the internet. The controller handles computing overhead when the computer connects to the internet through the modem interface.

### BRIEF DESCRIPTION OF THE DRAWINGS

FIG. 1 is a simplified block diagram of a printer that includes a modem in accordance with an embodiment of the present invention.

FIG. 2 is a simplified flowchart that describes the establishment of an internet connection through the printer shown in FIG. 1 in accordance with an embodiment of the present invention.

### DESCRIPTION OF THE EMBODIMENT

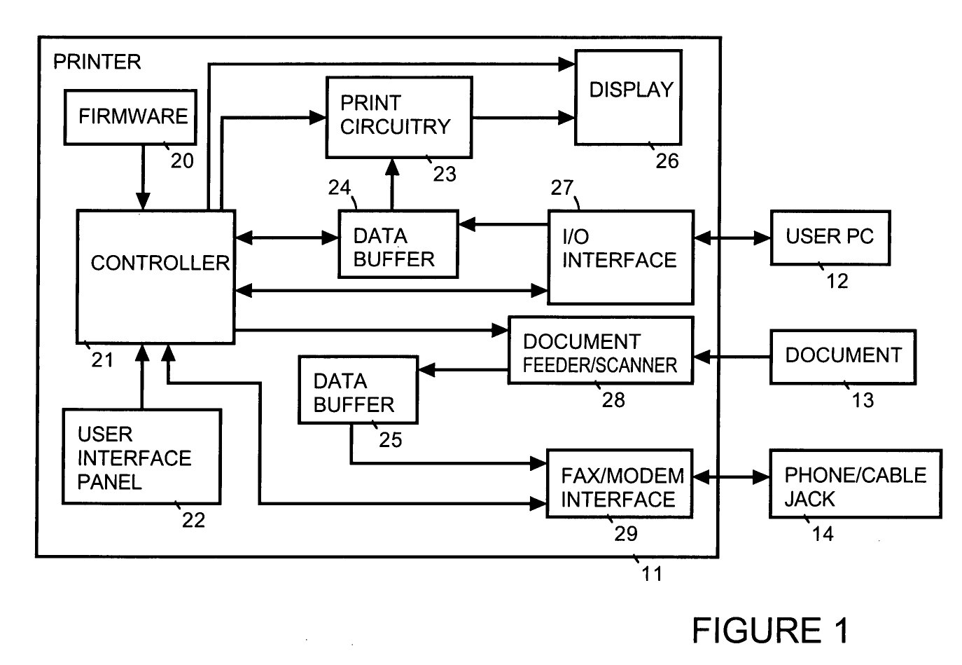

FIG. 1 is a simplified block diagram of a multi-function printer 11. Printer 11 communicates with a user personal computer (PC) 12 or other type of computer system through an input/output (I/O) interface 27. For example, I/O interface 27 is a universal serial bus (USB) interface, a parallel interface, an 802.11 interface or another I/O interface. A fax/modem interface 29 is used to connect printer 29 to a telephone line or cable jack 14.

Operation of printer 11 is controlled by a controller 21. Controller 29 is also used to control fax/modem interface 29. Firmware 20 contains program code for controller 21. A user can interface with controller 21 through a user interface panel 22. Print data is buffered by a data buffer 24 before being printed by print circuitry 23. For example, print circuitry 23 includes all the circuitry and mechanics necessary to print documents using laser printing technology, inkjet technology or another printing technology. A display 26 informs a user of print progress, provides error messages and so on. For example, display 26 is implemented as a liquid crystal display (LCD) or is implemented as a light emitting device (LED) display.

A document feeder/scanner 28 is used to scan in a document 38, for example, to perform a fax of the document or to provide user PC 12 with a scanned image of document 13. When a fax is being performed, scanned in data is stored in a data buffer 25 before being transferred to fax/modem interface 29 for transmission to telephone/cable jack 14.

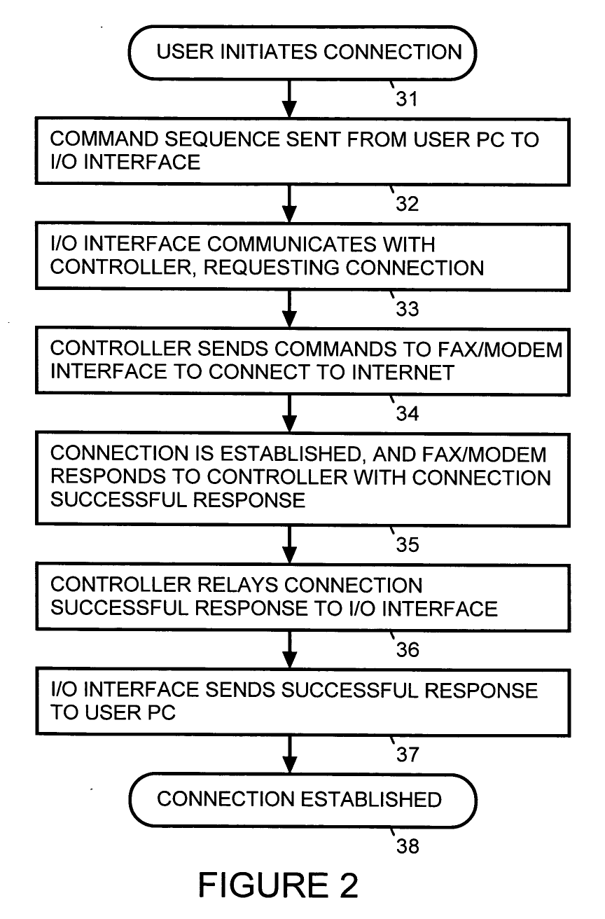

FIG. 2 is a simplified flowchart that describes the establishment of an internet connection through printer 11. In a block 31 a user on user PC 12 initiates a connection to the internet. In a block 32, a command sequence is sent from user PC 12 to I/O interface 27. In a block 33, I/O interface 27 communicates with controller 21, requesting an internet connection.

In a block 34, controller 21 sends commands to fax/modem interface 29 instructing fax/modem interface 29 to connect to the internet. In a block 35, fax/modem interface 29 establishes a connection to the internet through telephone/cable jack 14. For example, to establish the connection, fax/modem interface 29 operates as a telephone line modem, a DSL modem or a cable modem, depending upon the transmission medium available to make the internet connection.

Once the connection is established, fax/modem interface 29 responds to controller 21 with a connection successful response. In a block 36, controller 21 relays the connection successful response to I/O interface 27. In a block 37, I/O interface 27 sends the connection successful response to user PC 12. In a block 38, the connection is successfully established.

Once an internet connection is achieved, the user on user PC 12 communicates on the internet through the datapath established through printer 11. The user, thus, is able to communicate on the internet using fax/modem interface 29. CPU overhead for the connection is borne primarily by controller 21 and not by user PC 12. This can be a significant performance improvement over computer systems that use a software modem to communicate over the internet.

In one embodiment of the present application, user interface panel 22 provides for alphanumeric input. This allows a user using user interface panel 22 to directly instruct controller 21 to establish an internet connection. In this case controller 21 displays information from the internet on display 26. This allows for simplified browsing of the internet to perform simple tasks, such as to print out information from the internet directly using printer circuitry 23. This is useful for tasks such as quickly obtaining a map or directions to a particular location without the necessity of booting up user PC 12.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A printer, comprising:
print circuitry;
an input/output interface that provides connection to a computer;
a modem interface that allows the printer to connect to the internet; and,
a controller that handles computing overhead when the computer connects to the internet through the modem interface.

2. A printer as in claim 1 wherein the modem interface includes the ability to send and receive facsimile transmissions.

3. A printer as in claim 1 additionally comprising a document feeder.

4. A printer as in claim 1 additionally comprising:
a user interface panel; and,
a display.

5. A printer as in claim 1 additionally comprising:
a user interface panel; and,
a display;
wherein the controller handles computing overhead when a user, through the user interface panel, instructs the controller to connect to the internet through the modem interface, the controller communicating information to the user through the display.

6. A method for establishing an internet connection for a user, comprising the following steps:
forwarding a user request for an internet connection from a computer on which the user makes the request for the internet connection to a printer that has a modem interface; and,
establishing the internet connection using the modem interface within the printer, including:
providing computing overhead for the internet connection established using the modem interface primarily by a controller within the printer.

7. A method as in claim 6 additionally including the following:
supporting communication between the printer and the computer using an input/output interface within the printer.

8. A method as in claim 6 additionally including the following:
providing facsimile capability through the modem interface.

9. A printer, comprising:
means for printing documents;
means for providing connection to a computer;
means for providing a connection between the computer and the internet, the connection being provided through the printer; and,
means for handling, by the printer, processing overhead for the connection between the computer and the internet.

10. A printer as in claim 9 wherein means for providing a connection between the computer and the internet, the connection being provided through the printer includes the ability to send and receive facsimile transmissions.

11. A printer as in claim 9 additionally comprises means for scanning a document.

12. A printer as in claim 9 additionally comprising:
means for receiving input directly from the user; and,
means for directly display information to the user.

13. A printer as in claim 9 additionally comprising:
means for receiving input directly from the user, the input including instructions to the printer to establish a direct connection between the printer and the internet; and,
means for directly displaying information to the user, including information pertaining to the direct connection between the printer and the internet.

14. A method for establishing an internet connection for a user, comprising the following steps:
receiving a user request for an internet connection by a printer that has a modem interface; and,
establishing the internet connection using a modem interface within the printer, including:
providing computing overhead for the internet connection established using the modem interface primarily by a controller within the printer.

15. A method as in claim 14 additionally including the following:
providing facsimile capability through the modem interface.

16. A method as in claim 14 wherein the user request is received by the printer through a user computer on which the user makes the user request.

17. A method as in claim 16 additionally including the following:
supporting communication between the printer and the user computer using an input/output interface within the printer.

18. A method as in claim 14 wherein the user request is received by the printer through a user interface on the printer.

19. A method as in claim 14 additionally comprising:
displaying connection information to the user via a display that is part of the printer.
